(19) United States
(12) Patent Application Publication
(10) Pub. No.: US 2006/0219693 A1
(43) Pub. Date: Oct. 5, 2006

(54) Personalized appliance and method of making the same

(75) Inventors: George W. Earls, Louisville, KY (US); Thomas W. Colbert, Louisville, KY (US)

Correspondence Address: SENNIGER POWERS, ONE METROPOLITAN SQUARE, 16TH FLOOR, ST LOUIS, MO, 63102, US

(73) Assignee: ADVANCE DISTRIBUTION SERVICES, INC., Louisville, KY (US)

(21) Appl. No.: 11/370,615

(22) Filed: Mar. 8, 2006

Related U.S. Application Data
(60) Provisional application No. 60/662,809, filed on Mar. 17, 2005.
(60) Provisional application No. 60/715,337, filed on Sep. 8, 2005.

(51) Int. Cl. A21B 1/00; A21B 1/22; F27D 11/00

(52) U.S. Cl. 219/399

(57) ABSTRACT

In one aspect, a method of personalizing an appliance before it is received by a consumer includes receiving the appliance in a shipping package and removing the appliance from the package. A thin panel is attached to a major surface of the appliance. The thin panel has an imprinted graphic image on a front surface thereof and is sized and shaped to cover the entirety of the major surface. The appliance with the panel is packaged and shipped for eventual delivery to the consumer. In another aspect, a personalized appliance has a sport-related decoration comprising a sport venue graphic depicting a sport venue. A method of personalizing an appliance includes applying this sport-related decoration to the appliance, re-packaging the appliance, and shipping the packaged appliance for eventual delivery to a buyer.

### CROSS-REFERENCE TO RELATED APPLICATION

This application claims priority to U.S. Provisional Application Nos. 60/662,809 filed on Mar. 17, 2005, entitled METHOD OF PERSONALIZING AN APPLIANCE and to and 60/715,337 filed on Sep. 8, 2005, entitled PERSONALIZED APPLIANCE AND METHOD OF MAKING THE SAME, the entireties of both of which are hereby incorporated by reference.

### BACKGROUND OF INVENTION

This invention relates generally to appliances with graphic images and methods of making the same.

Traditionally, appliances such as refrigerators and dishwashers generally have the same type of finishes (white, black or stainless steel) and thus the same “standard” or “look-alike” appearances. Recently however “personalized appliances” have been introduced. A personalized appliance incorporates a graphic image, such as a logo, college sports team, artwork, or any other image, on one or more sides of the appliance to give it a more unique, more interesting appearance. For example, for use with a refrigerator, a graphic image is typically incorporated on the doors of the refrigerator.

One way to incorporate a graphic image on one or more sides of an appliance is by use of a kit, often referred to as a panel kit. The panel kit is a do-it-yourself system sold to an owner or future owner of an appliance for installation by the owner. A panel kit may include one or more panels bearing imprinted graphic images, a transparent cover sheet for each panel, and one or more frames (similar to picture frames) for holding the panels and cover sheets. The cover sheets may be either separate or integral with the frames. The one or more panels are shaped and sized (either by the kit-maker or the consumer) to cover a selected side of an appliance. Typically, the panels are made of an acrylic or vinyl material. To install the panels on doors of a refrigerator, for example, the consumer removes trim, plugs, handles and any nameplates on the doors of the refrigerator. Frames holding panels and associated cover sheets are then attached (e.g., using adhesive) to the perimeters of the refrigerator doors. In some kits the frames or cover sheets may have handles attached thereto, in which case the original handles are discarded.

The frames of the panel kits, and thus the panels held by the frames, are typically not permanently attached to the appliance. Moreover, the graphic images on the panels typically do not have good color or sharpness. The graphic images tend to appear dull and/or fuzzy. Also, the panels do not have the appearance of being an integral original equipment manufacturer (OEM) feature of the refrigerator. Instead, the panels tend to look like add-ons or additions to the refrigerator because, for one reason, there is not a tight (i.e., close) fit between the frames (including the cover sheets) and the panels and the panels and the appliance. Gaps between the frames (including the cover plates) and the panels and between the panels and the appliance are readily visually apparent.

There is a need, therefore, for an improved appliance panel system and for an improved method of installing appliance panel systems.

### SUMMARY OF THE INVENTION

In one aspect, the present invention is directed to a method of personalizing an appliance. The appliance is received in a shipping package, and the appliance is removed from the package. A graphic image is applied to a major surface of the appliance so that it covers substantially the entirety of the major surface. The appliance is re-packaged with the graphic image applied to the appliance. The packaged appliance is shipped for eventual delivery to the buyer.

In another aspect, an appliance comprises a body having at least one major surface. The panel system comprises at least one thin metal panel attached to the major surface of the appliance. The at least one panel has an imprinted graphic image on the front surface thereof. The at least one panel is sized and shaped to cover the entirety of the major surface of the appliance.

In yet another aspect, a personalized appliance comprises a body having a first door having a major surface. A first sport-related decoration covers substantially the entirety of the major surface. The first sport-related decoration comprises a sport venue graphic depicting a sport venue.

Other objects and features will be in part apparent and in part pointed out hereinafter.

### BRIEF DESCRIPTION OF THE DRAWINGS

FIG. 1 is a perspective of one embodiment of an appliance with panels having imprinted graphics;

FIG. 2 is similar to FIG. 1 with the panels exploded from the appliance;

FIG. 3 is a flow chart illustrating one method of imprinting a graphic image on a panel of the present invention;

FIG. 4 is a flow chart illustrating one method of installing an appliance panel system of the present invention;

FIG. 5 is a perspective of another embodiment of an appliance having a sport venue graphic;

FIG. 6 is a perspective of the appliance of FIG. 5 wherein the sport venue graphic depicts a baseball field;

FIG. 7 is a perspective of the appliance of FIG. 5 wherein the sport venue graphic depicts a basketball court;

FIG. 8 is a perspective of the appliance of FIG. 5 wherein the sport venue graphic depicts a football field;

FIG. 9 is a perspective of the appliance with a panel having the sport venue graphic depicted thereon being exploded from the appliance;

FIG. 10 is a perspective of the appliance with a panel kit securing the sport venue graphic to the appliance;

FIG. 11 is similar to FIG. 10 with the panel kit exploded from the appliance;

FIG. 12 is another embodiment of an appliance having side-by-side doors with a sport venue graphic;

FIG. 13 is another embodiment of an appliance similar to the appliance of FIG. 5 with a team graphic logo on a bottom door;

FIG. 14 is similar to FIG. 6 with a team logo graphic on a bottom door;

FIG. 15 is similar to FIG. 14 with panels exploded from the appliance;

FIG. 16 is similar to FIG. 14 except that a panel kit secures the sport venue graphic and the team logo graphic to the appliance;

FIG. 17 is similar to FIG. 16 with the panel kit exploded from the appliance; and

FIG. 18 is another embodiment of an appliance similar to FIG. 12 except that a team logo graphic is disposed on lower portions of the doors.

Corresponding reference characters indicate corresponding parts throughout the drawings.

### DETAILED DESCRIPTION OF THE DRAWINGS

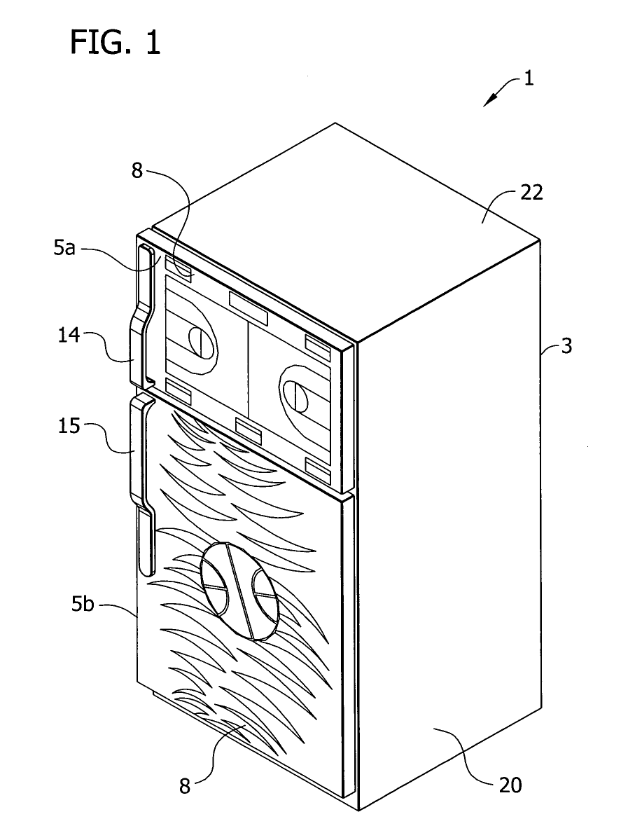

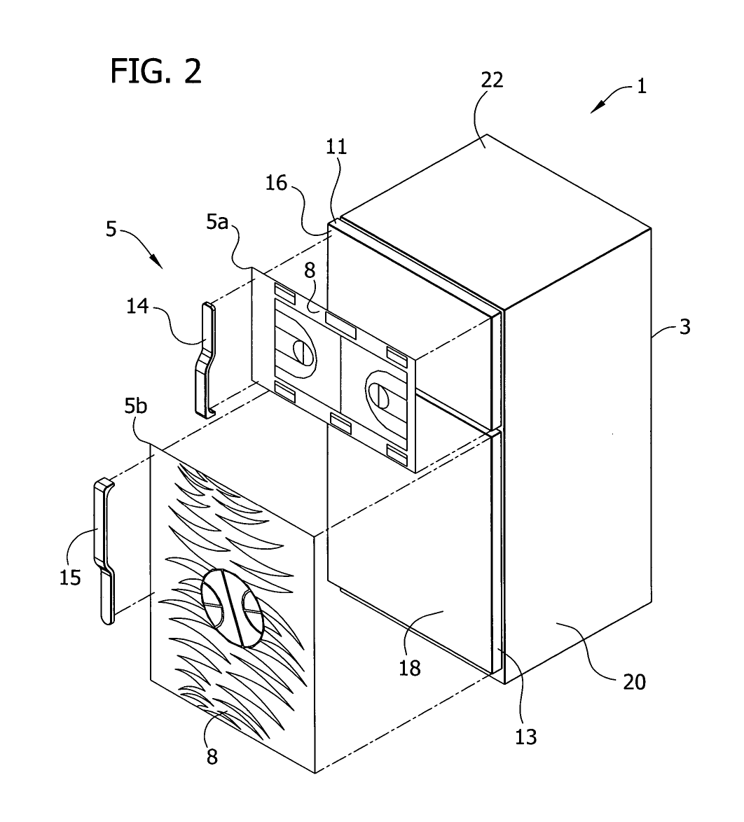

Referring now to the drawings, FIGS. 1 and 2 show one embodiment of an appliance of the present invention, designated in its entirety by reference numeral 1. The appliance 1, in this case a refrigerator, comprises a body 3 and an appliance panel system, generally indicated at 5, of the present invention. The refrigerator 1 is a conventional model and well known in the art. The appliance panel system 5 comprises one or more panels 5a, 5b and means, such as adhesive material, for attaching the panel(s) to the refrigerator. The one or more panels 5a, 5b have graphics 8 imprinted on front surfaces of the panels.

As shown best in FIG. 2, the body 3 of the refrigerator 1 includes an upper door 11 (a freezer door) hinged on the body and a lower door 13 (a fresh food door) hinged on the body. The upper and lower doors 11, 13 have front surfaces 16, 18, respectively, which together define a front side of the body 3 of the refrigerator 1. Each door 11, 13 has a door handle 14, 15, respectively, attached to its front surface 16, 18. The body 3 of the refrigerator 1 also has a left side (not visible), a right side 20, a top side 22, a bottom side (not visible) and a rear side (not visible). It is understood that the refrigerator 1 may have other configurations. For example, it may be a mini-refrigerator having only one door or a refrigerator having side-by-side doors. It is also understood that the present invention is applicable to other appliances having sides with large surface areas, such as ranges, dishwashers, wine coolers, beverage centers, washers, dryers, ice machines, compactors, and freezers.

In the illustrated embodiment, the upper and lower panels 5a, 5b of the appliance panel system 5 are attached to respective upper and lower doors 11, 13 of the refrigerator 1. For reasons discussed below, the panels 5a, 5b are preferably formed from sheet metal (e.g., aluminum), although the panels can be of any material that has a surface covered with a suitable coating, such as a sublimatable coating that can withstand sublimation temperatures (e.g., ceramic material). The panels 5a, 5b are preferably between about 0.025 inches and 0.250 inches thick. In one embodiment, the panels are 0.025 white aluminum sheets at 90 gloss.

As illustrated in FIG. 1, the upper and lower panels 5a, 5b and graphics 8 thereon are relatively large so that the desired visual impact is obtained, i.e., the appliance appears to be “personalized” according to the taste of the consumer owning the appliance. To this end, the panels 5a, 5b are preferably sized and shaped to cover substantially the entire surface areas of the respective upper and lower doors 11, 13 of the refrigerator 1. However, it will be understood that it is within the scope of this invention for a panel to cover less than the entire surface area of a door or a side of an appliance, so long as the panel is sufficiently large to cover a “major surface” of at least one side of the appliance. As used herein, the term “major surface” is a surface representing a substantial percentage of the overall area of a side of the appliance (e.g., the left, right, top, bottom, front and/or rear side), preferably at least about 10% of such overall area, even more preferably at least about 20% of such overall area, even more preferably at least about 30% of such overall area, even more preferably at least about 40% of such overall area, even more preferably at least about 50% of such overall area, even more preferably at least about 60% of such overall area, even more preferably at least about 70% of such overall area, even more preferably at least about 80% of such overall area, even more preferably at least about 90% of such overall area, and even more preferably about 100% of such overall area.

It is contemplated that a panel of this invention may be attached to any major surface (e.g., side) of the appliance, and that more than one panel may be attached to more than one major surface of the appliance. For example, a second panel having a graphic image thereon can be attached to and cover substantially an entire second major surface of the appliance. Similarly, a third panel having a graphic image thereon can be attached to and cover substantially an entire third major surface of the appliance. Additional graphic image panels attached to and covering substantially entire respective additional major surfaces are also contemplated.

The panels 5a, 5b are permanently attached to the refrigerator 1 using means, such as an aggressive industrial adhesive material, which secures the rear surface of each panel 5a, 5b face-to-face against a selected surface of the appliance, such as the doors 11, 13 of the refrigerator. The adhesive should allow a tight (i.e., close) fit between the panel(s) and the appliance. Examples of suitable adhesives include double sided tape (e.g., 3M product #9832). Other adhesives are within the scope of this invention. Moreover, other means may be used to attach the panel(s) to the appliance, such as fasteners (e.g., threaded screws, tabs, hooks, bolts) and/or welding.

As stated above, each panel 5a, 5b of the present invention has a graphic image(s) 8 imprinted on its front surface. The image 8 can be sized and shaped to cover substantially the entire front surface of the panel 5a, 5b. Alternatively, the image 8 may cover less than the entire front surface of a panel, so long as the size of the image on the panel is sufficient to give the appliance a “personalized” look in which the graphic image is readily apparent when the appliance is viewed and adds to the overall “look” or appearance of the appliance. The image 8 should cover a substantial percentage of the overall area of the front side of the panel 5a, 5b, such as at least about 10% of such overall area, or at least about 20% of such overall area, or at least about 30% of such overall area, or at least about 40% of such overall area, or at least about 50% of such overall area, or at least about 60% of such overall area, or at least about 70% of such overall area, or at least about 80% of such overall area, or at least about 90% of such overall area, or about 100% of such overall area. Each graphic image may include any number of trademarks, logos, college sports teams, artwork or any other desirable design. In one embodiment, the graphic images 8 of the upper and lower panels 5a, 5b combine to form single logo that is divided between the two panels. In another embodiment, the logo is contained entirely within the area of the upper panel 5a or the lower panel 5b. Preferably, the graphic image 8 is digitally designed using a computer, but the image can be formed in any manner.

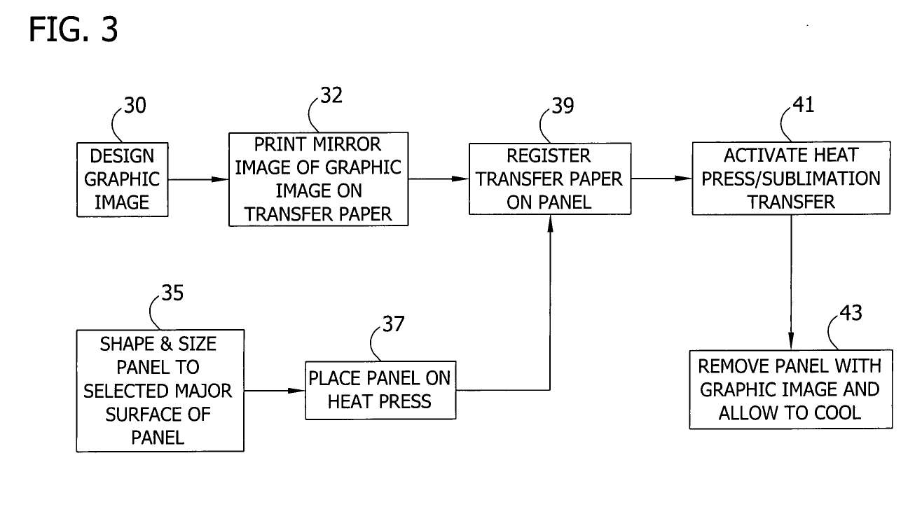

FIG. 3 is a flow chart illustrating one embodiment of a process of imprinting a graphic image 8 on a panel 5a, 5b using a sublimation process. The graphic image 8 is designed, e.g., using a computer, at step 30, and a mirror image of the graphic image is printed on transfer paper using dyes at step 32. As will be understood by those skilled in the art, the transfer paper has a coated surface adapted to accept and release the dyes. Preferably, the dyes used in the sublimation process are formulated to be UV resistant to fading. An exemplary transfer dye is SubliJet®IQ. SubliJet®IQ is a registered trademark of Sawgrass Technologies, Inc. A panel 5a, 5b on which the graphic image is to be imprinted is sized and shaped at 35, for example using shears, to substantially conform to the size and shape of the appliance 1, such as the upper door 11 or lower door 13 of the refrigerator shown in FIG. 1. The panel 5a, 5b has a coating that accepts dyes during the sublimation transfer process. For example, the coating may comprise a base coat (e.g., a thermosetting polyester enamel such as white appliance enamel sold by Lilly Industries, Inc. of Indianapolis, Ind. under Code 95101-7299) and a substantially clear top coat (e.g., thermosetting polyester sold by Lilly Industries, Inc. under Code 95110-7300). Preferably, the panel 5a, 5b may be sheet aluminum or other sheet metal, or any material that is sublimatable (i.e., material that is properly coated and can withstand sublimation temperatures). The panel 5a, 5b is placed on a heat press at step 37, and the paper with the graphic image is registered on the panel at step 39. The heat press is activated and the image 8 is transferred to the panel 5a, 5b at step 41. The panel is then removed and allowed to cool at step 43. The heat press time, temperature and pressure may vary. Preferably, the time in the heat process is between about 40 seconds and 7 minutes, and the temperature is between about 350° F. to 450° F. Sublimation processes for imprinting an image on sheet metal, such as aluminum, are well known in the art, as exemplified by the disclosures in U.S. Pat. Nos. 5,985,416 and 5,856,267, both of which are herein incorporated by reference. Images 8 may be printed on panels 5a, 5b in other ways. The graphics thus formed are preferably clear and sharp, and the colors are vibrant.

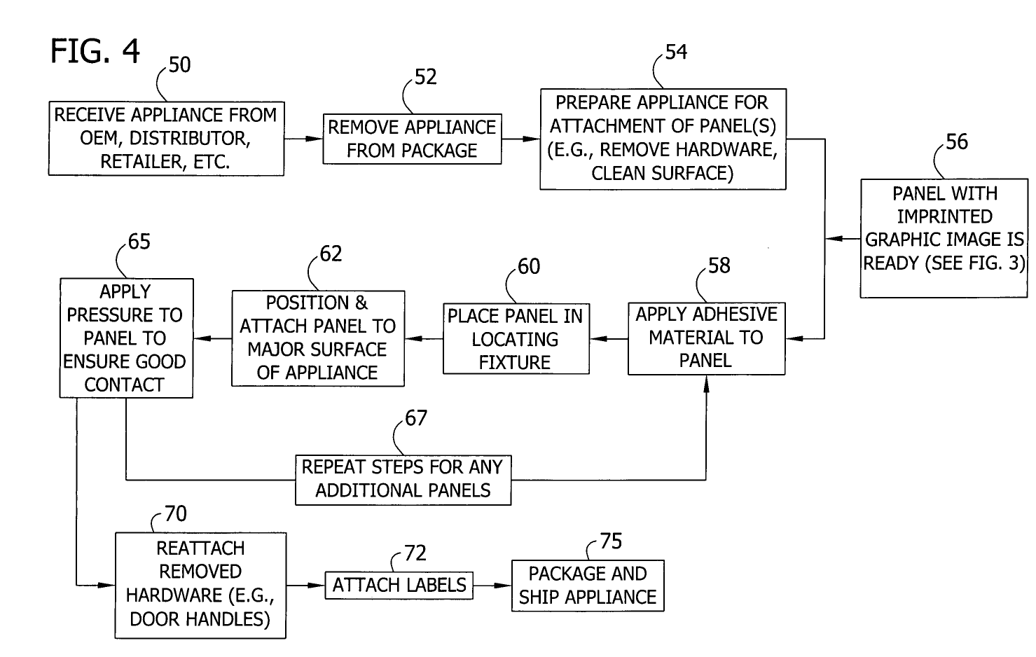

FIG. 4 is a flow chart showing the steps in a preferred method of installing the appliance panel system 5 on an appliance, such as the refrigerator 1 illustrated in FIG. 1. (The refrigerator 1 of FIG. 1 is being used for illustrative purposes only, and it is understood that the method may also be used with other types of refrigerators or other appliances.) At step 50, the refrigerator 1 is received from an original equipment manufacturer (OEM), a distributor, a retailer, or other supplier of appliances. The refrigerator 1 is removed from its original package at step 52. It is understood that various OEMs, distributors, and the like use different packages and packaging techniques to ship their appliances (e.g., crates, stretch wrap, cartons, etc.) By way of example but not limitation, an appliance may be shipped in a corrugated box having a lid at a top and/or a bottom of the box that is secured in place by one or more bands (e.g., metal or plastic strips) wrapped around lids. Flaps, adhesively bonded together, may also be disposed at the top and/or the bottom of the box to seal the appliance in the box. With this type of package, one or more bands may be cut and the flaps are carefully opened using a special tool (e.g., a modified putty knife) that is adapted to unfasten the flaps without causing significant damage to the flaps or the box. As discussed below, preferably, where appropriate and feasible, care is taken to minimize damage to the package and to substantially preserve the integrity of the box.

At step 54 the refrigerator is prepared for attachment of the panel(s) 5a, 5b to a selected side, such as the front doors 11, 13. During step 54, the door handles 14, 15 of the refrigerator 1 are removed, and any other hardware and/or other parts that are protruding from the front side of the doors are also removed. The front surface area of the doors 11, 13 are also cleaned at step 54. This is done to ensure the adhesive bonds properly to the doors 11, 13.

Before the panels 5a, 5b are attached to the refrigerator 1, they are preferably already sized and shaped, as described above, and the graphics 8 are imprinted on the panels preferably using the sublimation process described above or some other suitable process at step 56. In one embodiment, at step 58, adhesive material is applied to one of the panels 5a, 5b. In one embodiment at step 60, a locating fixture is used to properly align the panel 5a, 5b relative to the refrigerator 1 and then to properly position the panel on the refrigerator. The locating fixture may comprise a frame, for example, that is positioned, sized and shaped to receive a panel 5a, 5b such that when the panel is received in the frame, it is aligned with the front surface 16, 18 of a respective door 11, 13. Other ways of aligning the panel 5a, 5b relative to the appliance 1 are within the scope of this invention. After the panel 5a, 5b is properly aligned using the locating fixture, the panel is positioned on and attached to the refrigerator 1 at step 62. Pressure is applied to the tape (adhesive) areas of the panel 5a, 5b at step 65, preferably using a roller or other pressing instrument, to ensure adequate adhesive contact between the panel and the tape and the appliance 1 and the tape. The foregoing steps are repeated at step 67 for the next panel to be applied, if there is one.

After the panels 5a, 5b are attached to the refrigerator 1, the previously removed hardware and any other removed parts of the refrigerator are reattached to the refrigerator at step 70. For example, the door handles 14, 15 are reattached to the refrigerator 1 using the same fasteners (e.g., threaded screws) which are inserted through the handle, the panels 5a, 5b and the doors 11, 13, as shown in FIG. 2. Optionally, at step 72, label(s) (e.g., bar code(s)) are also attached to the appliance 1 to reference the finished product, i.e., the appliance with the panel system 5 affixed to it.

After work on the appliance is finished, it is re-packaged and shipped at step 75 for eventual delivery to a consumer. Preferably, the finished appliance is re-packaged in the original package in which it was received, although a new package may be used either by choice or because the original packaging was damaged or destroyed (e.g., as in the case of an original stretch wrap product). Where the original package is a corrugated box of the type described above, the appliance is placed back into the box. (As discussed above, care is taken to preserve the box when removing the appliance). The flaps are resealed, and the top and/or bottom lids of the box are repositioned on the box and secured thereto using one or more new bands, preferably of the same type originally used. It is desirable in many cases that the appliance be re-packaged in the original package in such a way that the entire product appears to have come directly from the OEM, distributor, or the like, without modification by a third party. The appliance is then shipped to a buyer, such as a retailer, distributor, consumer or other entity.

The above process produces an appliance where the one or more panels (e.g., 5a, 5b) of the panel system appear to be an integral and original part of the appliance. The process produces a close fit between the panel(s) and the appliance. This process typically cannot be performed in a home or office environment using a do-it-yourself kit, since the necessary printing, installation and packaging equipment described above are generally not available to individual consumers. Overall, the process of this invention yields an appliance having a finished, professional appearance with clear and sharp graphics applied as an integral part of the appliance.

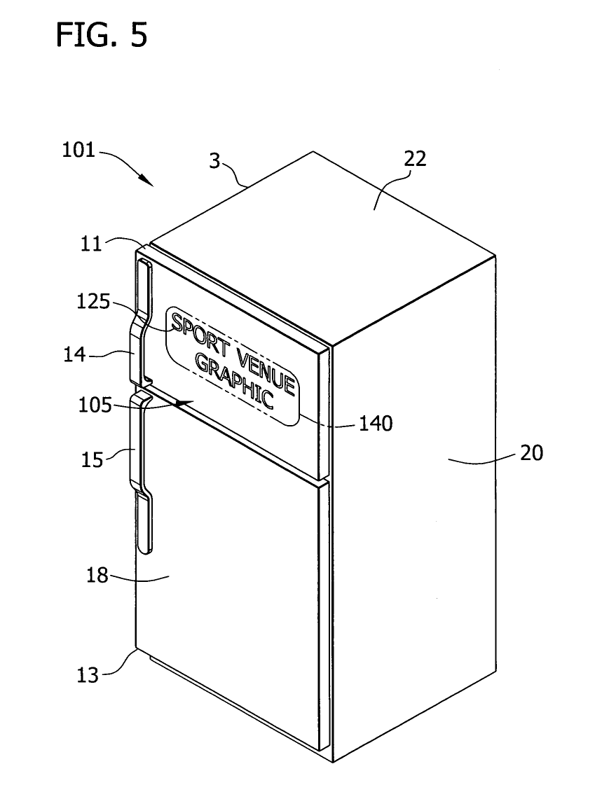

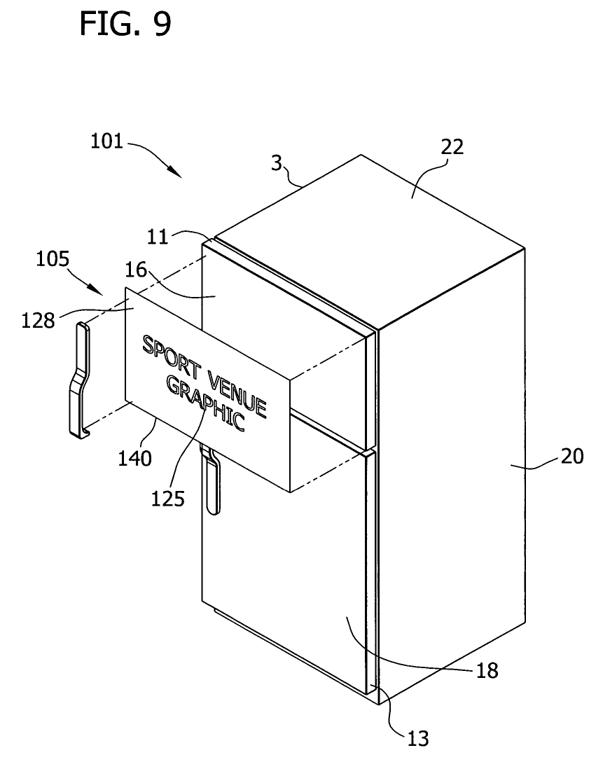

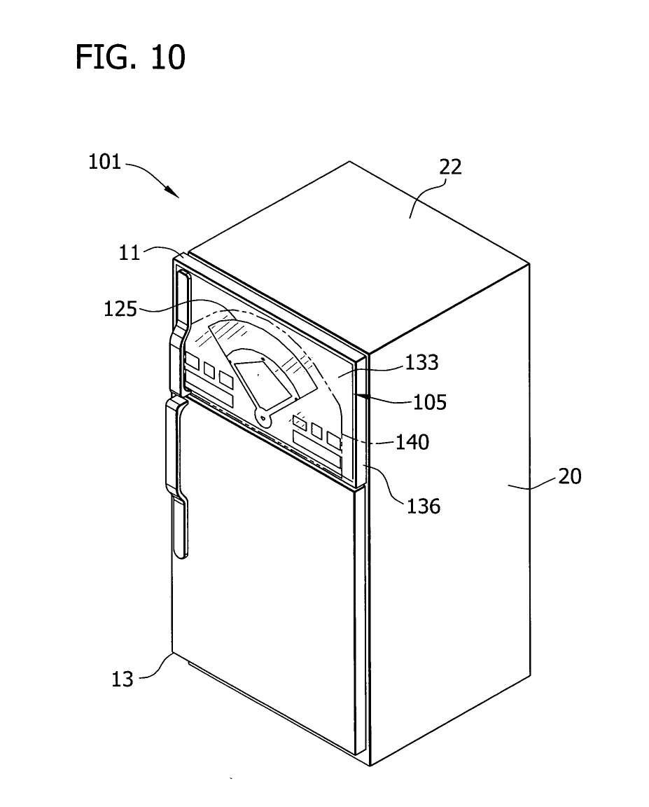

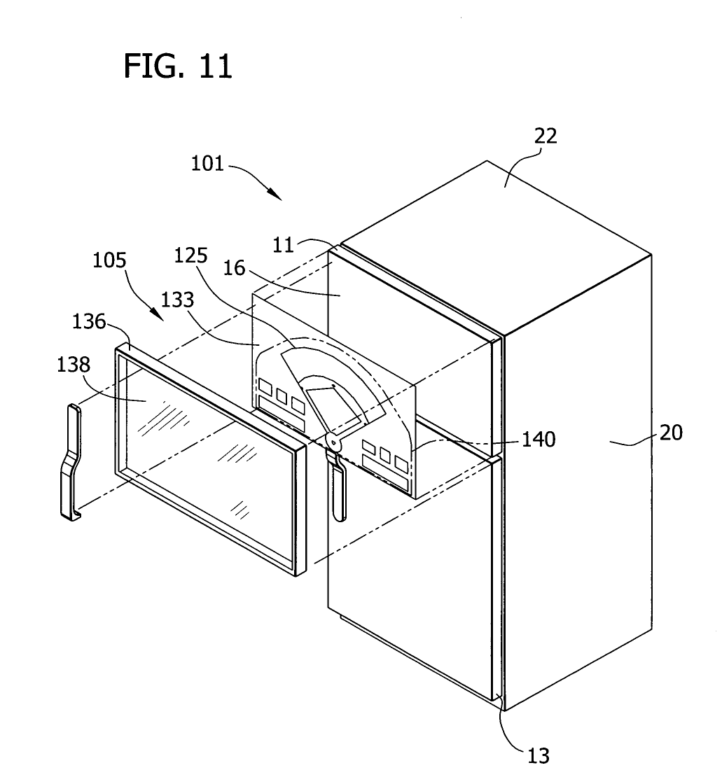

Referring now to FIGS. 5-11, another embodiment of an appliance is generally indicated in its entirety by reference numeral 101. The basic structure of the appliance 101, including the sides, surfaces, doors and handles, is similar to the basic structure of the appliance 1 in FIGS. 1 and 2; therefore, corresponding parts are indicated by corresponding reference numbers for convenience. The appliance 101 includes a sport-related decoration, generally indicated at 105, including a sport venue graphic 125 depicting a sport venue. Referring to FIG. 9, in one example, the sport venue graphic 125 is printed on a separate panel(s) 128 using the sublimation process described above. The panel 128 is attached to the appliance 101 in the same manner described above. As illustrated in FIGS. 10 and 11, the sport venue graphic 125 may alternatively be printed on a substrate or panel 133. The panel 133 is attached to the appliance 101 using a frame 136 (similar to a picture frame). This type of system is sometimes referred to in the art as a “panel kit”. Optionally, the panel kit may also include a transparent cover sheet 138 for each panel 133. The cover sheet 138 may be either separate or integral with the frame 136. The panel 313 may be made of an acrylic or vinyl material. Alternatively, the sport-related decoration 105 may be formed integrally with the body 3 of the appliance 101, such as by imprinting the sport venue graphic 125 directly on the major surface 16 of the door 11. Other ways of adding a sport-related decoration 105 of the present invention to a major surface of a door of an appliance are within the scope of this invention.

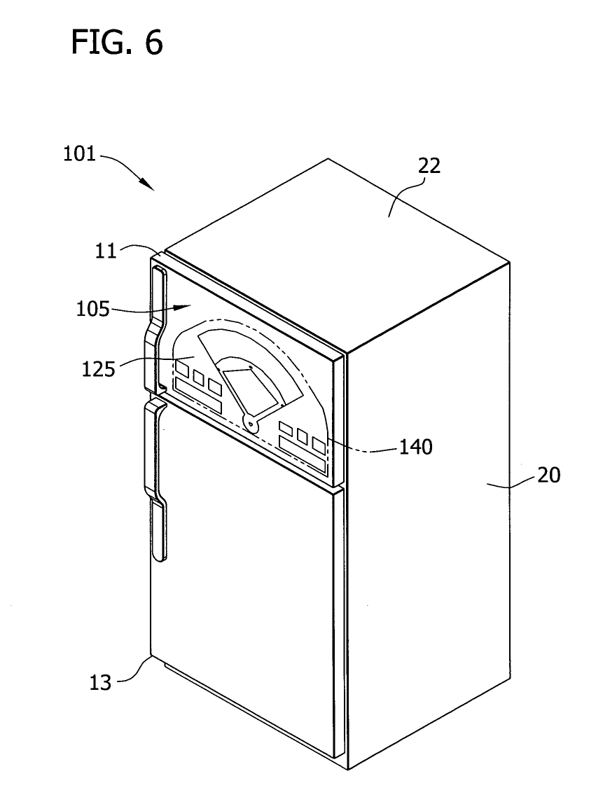

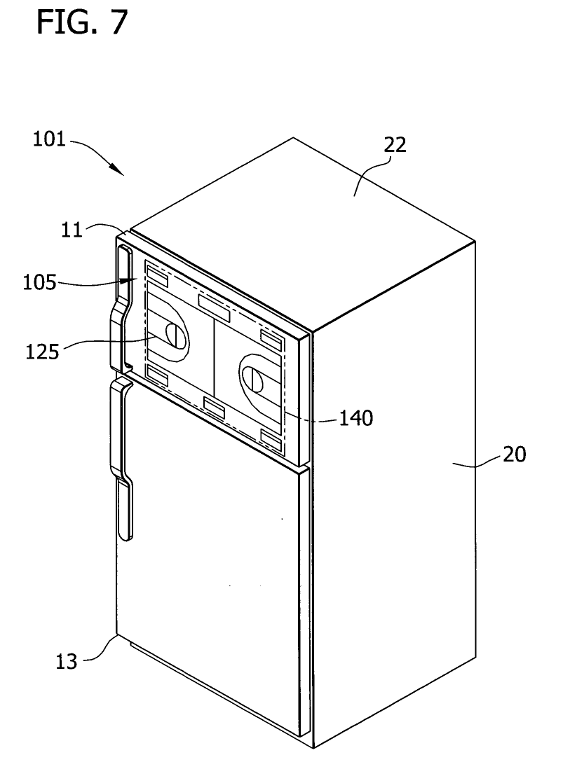

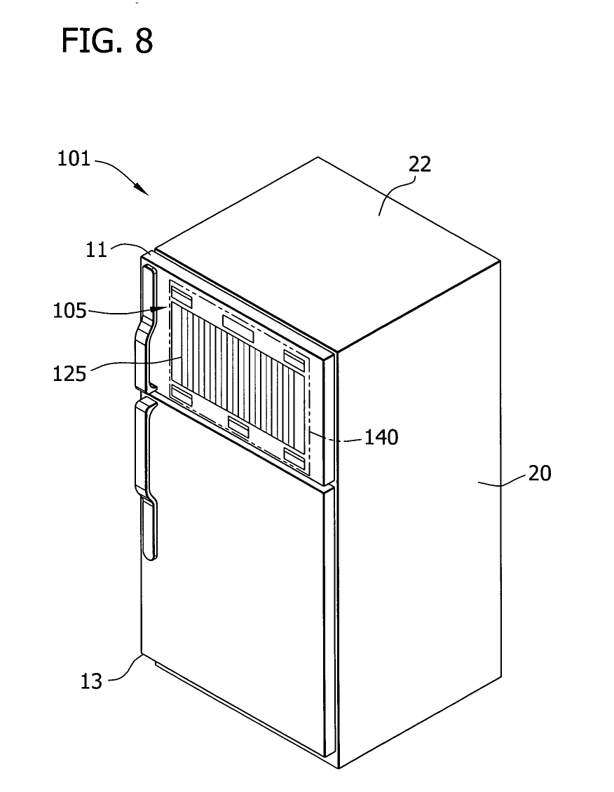

Examples of a sport venue graphic 125 include, but are not limited to, a baseball field graphic (FIG. 6), a basketball court graphic (FIG. 7), and a football field graphic (FIG. 8). Other sport venues (not shown), including but not limited to a soccer field, a hockey rink and a car racetrack, are contemplated and within the scope of this invention. It is understood that the graphics 125 embodied in FIGS. 6-8 are merely illustrative generic representations of exemplary sport venues. Deviations from these representations are within the scope of this invention. Moreover, it is also contemplated that the sport venue graphic 125 may of a specific venue, for example, a venue (e.g., a stadium or arena) that is home to a particular professional, college or other sport team. Optionally, a team name and/or logo (not shown) may be incorporated into the generic or specific sport venue graphic. Other sport-related indicia (e.g., score boards, time clocks) may also be included as part of the graphic.

The panels 128, 133 of FIGS. 9-11 are sized and shaped to cover substantially the entire area of the relevant major surface 16, 18 of the relevant door 11, 13. For example, the panels 128, 133 should cover at least about 10% of the area of the relevant major surface, or at least about 20% of such area, or at least about 30% of such area, or at least about 40% of such area, or at least about 50% of such area, or at least about 60% of such area, or at least about 70% of such area, or at least about 80% of such area, or at least about 90% of such area, or at least about 100% of such area. It is understood, however, that in other embodiments the sport-related decoration of the present invention may cover the major surface 18 of the lower door 13, or may cover doors of other appliances, such as the ones listed above.

In the illustrated embodiments of FIGS. 5-11, the image defined by the sport venue graphic 125 has a “footprint” 140 (perimeter outline) sized and shaped to cover a major portion of the front face of the relevant panel 128, 133. The size of the footprint 140 relative to the size of the front face of the panel 128, 133 should be sufficient to give the appliance a “personalized” look in which the graphic image is readily apparent when the appliance is viewed and adds to the overall “look” or appearance of the appliance. The footprint 140 should cover a substantial percentage of the overall area of the front face of the panel 128, 133, such as at least about 10% of such overall area, or at least about 20% of such overall area, or at least about 30% of such overall area, or at least about 40% of such overall area, or at least about 50% of such overall area, or at least about 60% of such overall area, or at least about 70% of such overall area, or at least about 80% of such overall area, or at least about 90% of such overall area, or about 100% of such overall area.

For other embodiments of the present invention in which the panel 128, 133 is not used and the graphic 125 is imprinted directly on the appliance, the footprint 140 of the graphic should cover a major portion of a relevant major surface of the appliance to give the appliance a “personalized” look in which the graphic image is readily apparent when the appliance is viewed and adds to the overall “look” or appearance of the appliance. For example, the footprint 140 should cover a substantial percentage of the overall area of the relevant major surface of the appliance, such as at least about 10% of such overall area, or at least about 20% of such overall area, or at least about 30% of such overall area, or at least about 40% of such overall area, or at least about 50% of such overall area, or at least about 60% of such overall area, or at least about 70% of such overall area, or at least about 80% of such overall area, or at least about 90% of such overall area, or about 100% of such overall area.

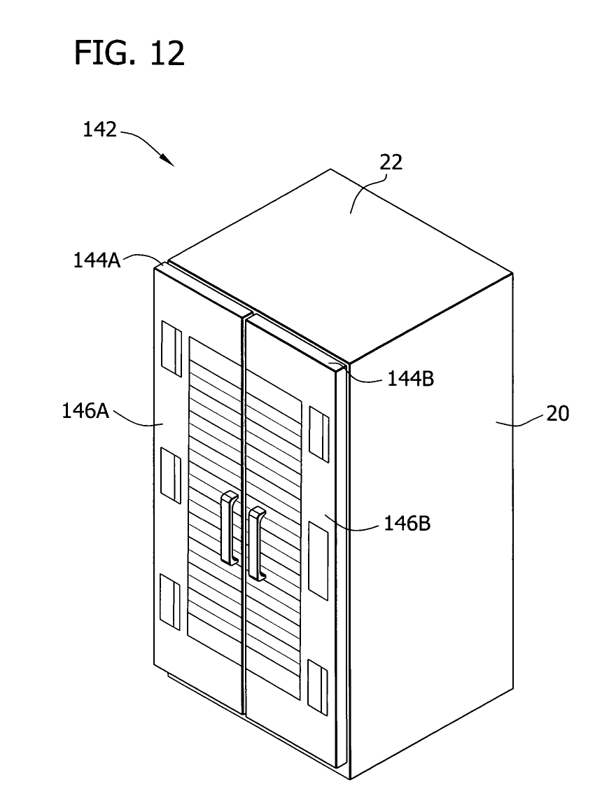

Referring to FIG. 12, it is also contemplated that the sport-related decoration 105 may be divided between two or more doors of an appliance. For example, in the illustrated embodiment of FIG. 12, a refrigerator 142 comprises side-by-side doors 144A, 144B. The sport-related decoration 105 comprises two panels 146A, 146B, one having a first portion (e.g., the first half) of the sport venue graphic 125 imprinted thereon, and the other having a second portion (e.g., the second half) of the sport venue graphic imprinted thereon. The sport venue graphic 125 depicts a football field for illustrative purposes, but it will be understood that this embodiment is not limited to football fields. Each panel 146A, 146B is secured to one of the doors 144A, 144B of the refrigerator 142 such that when the front surfaces of the panels are generally coplanar (e.g., when the doors are closed), the portions of the sport venue graphic 125 form a substantially complete image of the venue. The decoration 105 may be constructed and installed on the appliance in the same manner as described above with regard to FIGS. 9-11. In addition, although the illustrated embodiment is a refrigerator having side-by-side doors, this embodiment is applicable for all appliances having multiple doors, including refrigerators of the type having upper and lower doors, as shown in FIGS. 5-11.

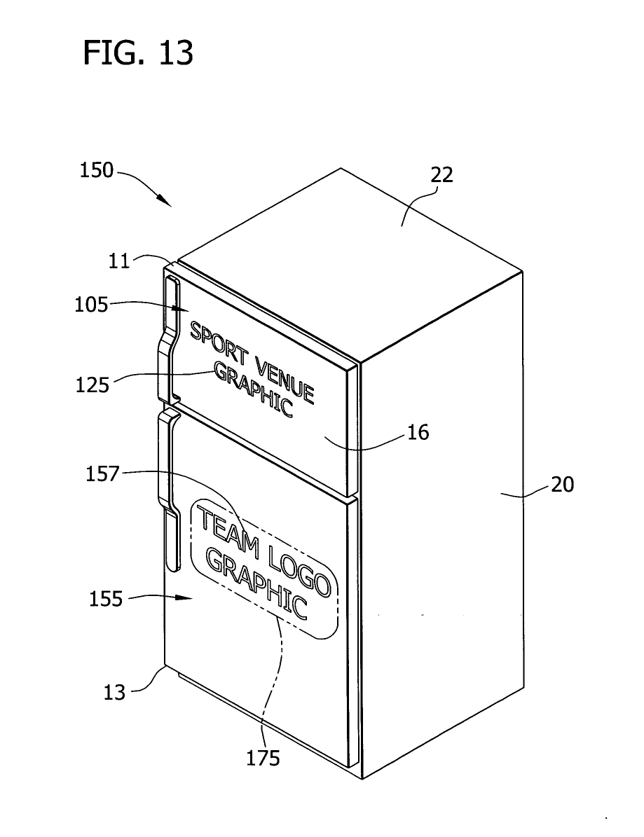

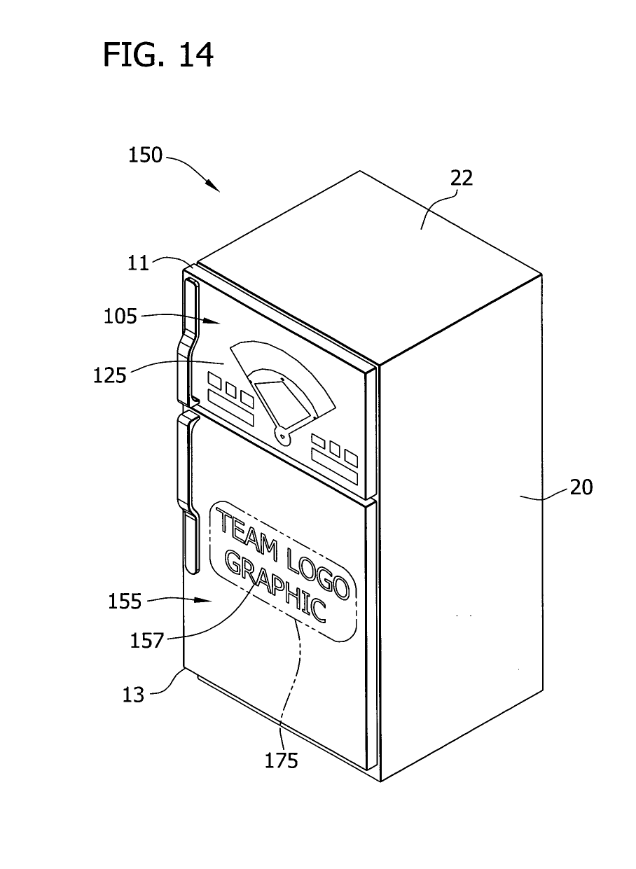

Referring now to FIGS. 13-17, another embodiment of the appliance of the present invention is generally indicated at 150. This illustrated embodiment is similar to the previous embodiment shown in FIGS. 5-11 and therefore corresponding parts are indicated by corresponding reference numerals for convenience. Like the previous embodiment show in FIGS. 5-11, this embodiment comprises a first sport-related decoration 105 comprising a sport venue graphic 125 covering substantially the entirety of a major surface 16 of an upper door 11 of the appliance 150. However, unlike the previous embodiment, this embodiment also comprises a second sport-related decoration 155 covering substantially an entirety of a major surface 18 of a lower door 13 of the appliance 150. The second sport-related decoration 155 comprises a sport team graphic 157 depicting a sport team. As an example, the sport team graphic 157 may be a team name and/or a team logo. Optionally, as discussed above, the first sport-related decoration 105 may have the same sport team incorporated in the sport venue graphic 157. It is understood that the location of the first and second sport-related decorations 105, 155, respectively, may be switched without departing from the scope of this invention. That is, the first sport-related decoration 105 can be associated with the lower door 13, and the second sport-related decoration 155 can be associated with the upper door 11. Other configurations, depending on the type of appliance, as described above, are within the scope of this invention.

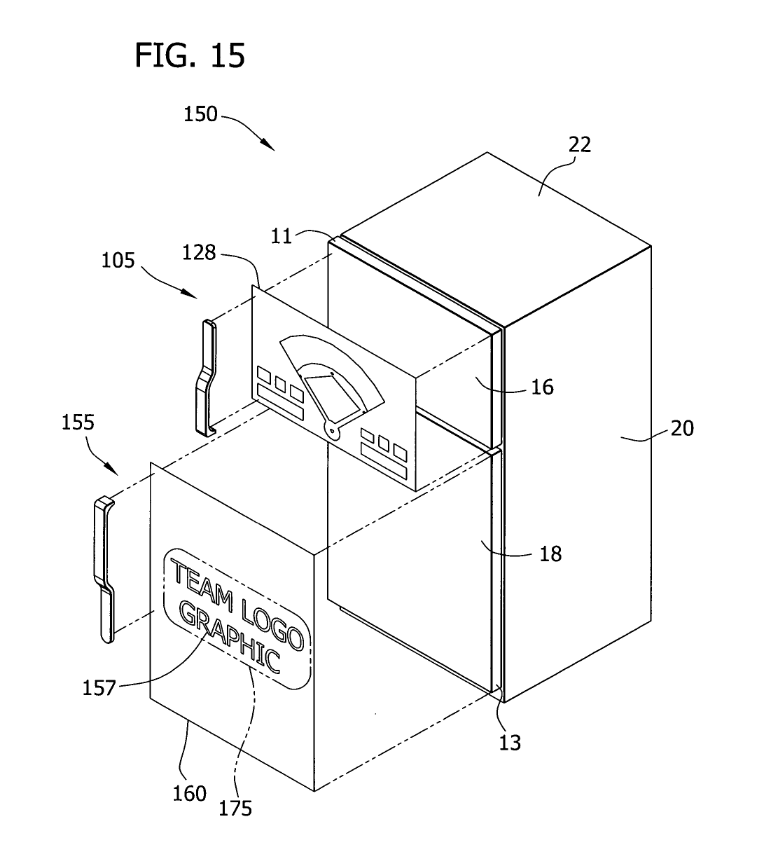

The second sport-related decoration 155 may be constructed in the same manner as the first sport-related decoration 105. For example, in the embodiment of FIG. 15 the second sport-related decoration 155 comprises a graphic substrate in the form of a thin panel 160 permanently attached to the lower door 13 of the refrigerator 150. The sport team graphic 157 is imprinted or otherwise formed on a front face of the panel 160, as described above. The second sport-related decoration 155 of this embodiment may be installed on the refrigerator 150 in substantially the same way as the first sport-related decoration 105.

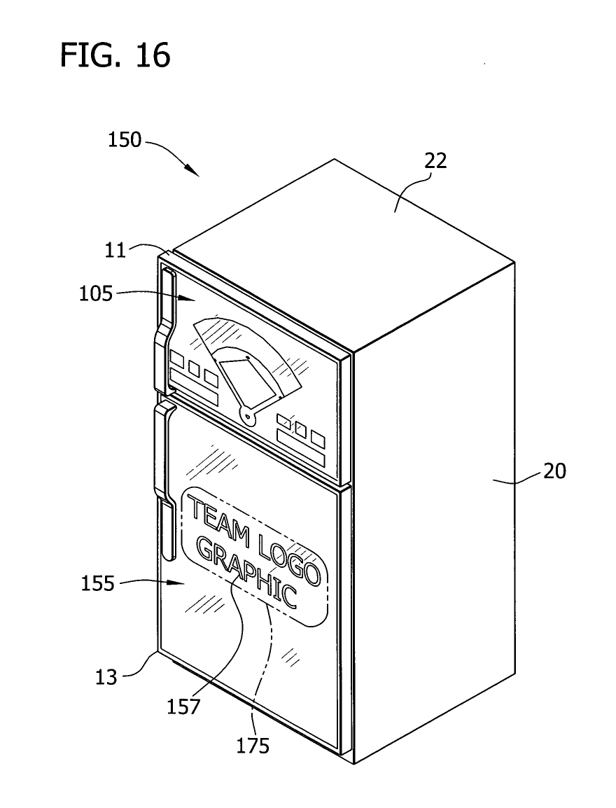

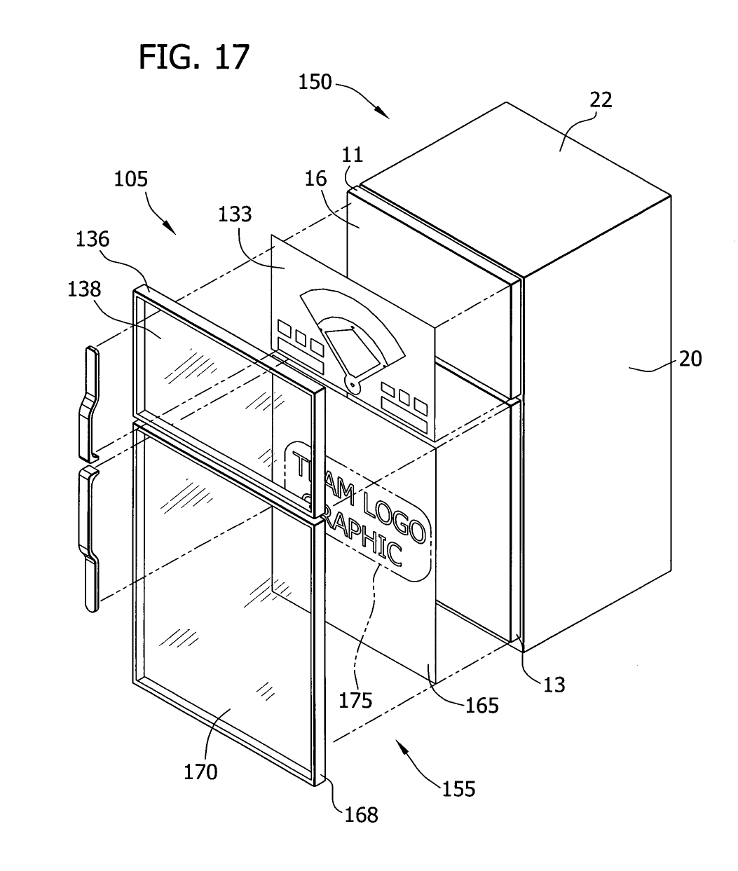

In another example, as depicted in the embodiment of FIGS. 16 and 17, the second sport-related decoration 155 comprises a thin panel 165 on which the sport team graphic 157 is imprinted and a frame 168 for holding the panel and securing it to the door 13 of the refrigerator. An optional cover sheet 170 may be used to cover the panel 168, as described above. This embodiment is installed on the refrigerator 150 in substantially the same way as described above with respect to the first sport-related decoration 105. Other ways of constructing and installing the second sport-related decoration are within the scope of this invention.

The panel 160 of FIG. 15 and the panel 165 of FIGS. 16 and 17 are sized and shaped to cover substantially the entire area of the major surface 18 of the relevant door 13. For example, the panels 160, 165 should cover at least about 10% of the area of the relevant major surface 18, or at least about 20% of such area, or at least about 30% of such area, or at least about 40% of such area, or at least about 50% of such area, or at least about 60% of such area, or at least about 70% of such area, or at least about 80% of such area, or at least about 90% of such area, or at least about 100% of such area.

In the illustrated embodiments of FIGS. 13-17, the image defined by the sport team graphic 157 has a “footprint” 175 (perimeter outline) sized and shaped to cover a major portion of the front face of the relevant panel 160, 165. The size of the footprint 175 relative to the size of the front face of the panel 160, 165 should be sufficient to give the appliance a “personalized” look in which the graphic image is readily apparent when the appliance 150 is viewed and adds to the overall “look” or appearance of the appliance. The footprint 175 should cover a substantial percentage of the overall area of the front face of the panel 160, 165, such as at least about 10% of such overall area, or at least about 20% of such overall area, or at least about 30% of such overall area, or at least about 40% of such overall area, or at least about 50% of such overall area, or at least about 60% of such overall area, or at least about 70% of such overall area, or at least about 80% of such overall area, or at least about 90% of such overall area, or about 100% of such overall area.

For other embodiments of the present invention in which the panel 160, 165 is not used and the sport team graphic 157 is imprinted directly on the appliance 150, the footprint 175 of the graphic should cover a major portion of the major surface of the relevant door 13 to give the appliance a “personalized” look in which the graphic image is readily apparent when the appliance is viewed and adds to the overall “look” or appearance of the appliance. For example, the footprint 175 should cover a substantial percentage of the overall area of the relevant major surface of the appliance, such as at least about 10% of such overall area, or at least about 20% of such overall area, or at least about 30% of such overall area, or at least about 40% of such overall area, or at least about 50% of such overall area, or at least about 60% of such overall area, or at least about 70% of such overall area, or at least about 80% of such overall area, or at least about 90% of such overall area, or about 100% of such overall area.

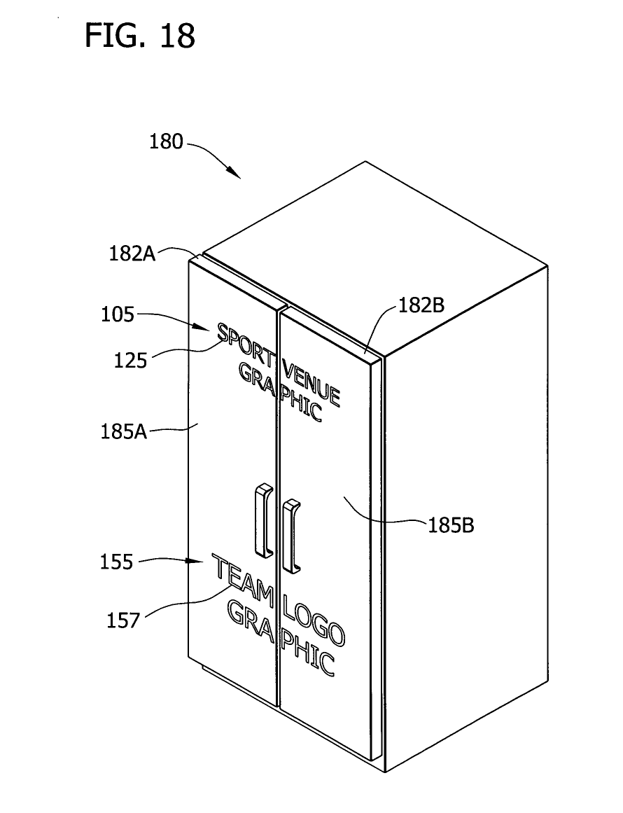

It is also contemplated that portions (e.g., halves) of the first sport-related decoration 105 and portions (e.g., halves) of the second sport-related decoration 155 can be disposed on the same doors of an appliance. For example, as illustrated in FIG. 18, a refrigerator 180 comprises doors 182A, 182B that are disposed side-by-side. A portion (e.g., half) of the sport venue graphic 125 and a portion (e.g., half) of the sport team graphic 157 can be disposed on one panel 185A attached to one door 182A while the other corresponding portions (e.g., halves) are disposed on another panel 185B attached to the other door 182B. As such, when the front surfaces of the panels 185A, 185B are generally coplanar (e.g., when the doors 182A, 182B are closed) the portions of the sport venue graphic 105 form a substantially complete image of the sport venue and the portions of the sport team graphic 157 form a substantially complete image of the sport team. Moreover, it is contemplated that the portions of the sport venue graphic 105 and the sport team graphic 157 that are disposed on the same door may also be imprinted or otherwise formed, as taught above, on different panels. As such, each door has two panels attached thereto, and each panel includes a portion of either the sport venue graphic or the sport team graphic.

In one exemplary use, the sport venue graphic 125 is imprinted on the relevant panel 128 using, for example, the sublimation process described above. Optionally, the sport team graphic 157 is imprinted on the relevant panel 160. In this example, one or both panels 128, 160 are attached to a refrigerator 101, 150 that is received from an original equipment manufacturer (OEM), a distributor, a retailer, or other supplier of appliances.

In another exemplary use, a panel kit including a relevant panel 133 having a sport venue graphic 125 imprinted thereon, and optionally another relevant panel 165 having a sport team graphic 157 imprinted thereon is provided to a consumer. The frame 136 or frames 136 and 168 and optional cover sheet 138 or cover sheets 138, 170 are also provided to the consumer. Door handles 14, 15 and other hardware protruding from the appliance are removed. The frame(s) 136, 168 is/are attached to the door of the appliance (e.g., using adhesive or other fastening means) so that it/they retain(s) the panel(s) 133, 165 on the appliance.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method of personalizing an appliance, comprising the steps of
receiving the appliance in a shipping package,
removing the appliance from the shipping package,
applying a graphic image to a major surface of the appliance so that it covers substantially the entirety of said major surface,
re-packaging the appliance with the graphic image applied to the appliance, and
shipping the packaged appliance for eventual delivery to a buyer.

2. A method as set forth in claim 1 wherein the step of applying a graphic image comprises applying a sport-venue graphic depicting a sport venue.

3. A method as set forth in claim 2 further comprising applying a sport team graphic depicting a sport team to the appliance so that it covers substantially the entirety of a second major surface of the appliance prior to said re-packaging step.

4. A method as set forth in claim 1 wherein the step of applying a graphic image comprises the step of attaching at least one thin panel to the major surface of the appliance, said at least one panel having the graphic image imprinted on a front surface thereof and being sized and shaped to cover substantially the entirety of said major surface.

5. A method as set forth in claim 4 wherein said major surface represents between 25% and 50% of an overall area of a side of the appliance.

6. A method as set forth in claim 4 wherein said major surface represents between 50% and 75% of an overall area of a side of the appliance.

7. A method as set forth in claim 4 wherein said major surface represents between 75% and 100% of an overall area of a side of the appliance.

8. A method as set forth in claim 4 further comprising the step of removing attached components of the appliance protruding from the major surface of the appliance before the step of attaching the at least one panel to the major surface of the appliance, and the step of reattaching the removed components to the major surface of the appliance after the panel is attached to the appliance.

9. A method as set forth in claim 4 further comprising the step of imprinting the at least one panel with said graphic image using a sublimation process.

10. A method as set forth in claim 4 wherein the step of receiving said appliance in a shipping package comprises receiving said appliance in a shipping package directly from an original equipment manufacturer.

11. A method as set forth in claim 4 wherein the graphic image comprises a sport venue graphic depicting a sport venue.

12. A method as set forth in claim 4 further comprising the step of attaching a second thin panel to a second major surface of the appliance prior to said re-packaging step, the second panel having an imprinted graphic image on a front surface thereof and being sized and shaped to cover the entirety of said second major surface.

13. A method as set forth in claim 12 further comprising attaching a third thin panel to a third major surface of the appliance prior to said re-packaging step, the third panel having an imprinted graphic image on a front surface thereof and being sized and shaped to cover the entirety of said third major surface.

14. An appliance comprising
a body having at least one major surface, and
a panel system comprising at least one thin metal panel attached to said major surface of the appliance, said at least one panel having an imprinted graphic image on a front surface thereof and being sized and shaped to cover the entirety of said major surface.

15. An appliance as set forth in claim 14 wherein said major surface represents between 75% and 100% of an overall area of a first side of the appliance.

16. A personalized appliance comprising
a body having a first door having a major surface, and
a first sport-related decoration covering substantially the entirety of said major surface, said first sport-related decoration comprising a sport venue graphic depicting a sport venue.

17. A personalized appliance as set forth in claim 16 wherein said first sport-related decoration comprises a thin panel permanently attached to said major surface, and wherein said sport venue graphic is imprinted on an outer face of said thin panel.

18. A personalized appliance as set forth in claim 16 wherein said first sport-related decoration comprises a frame adapted to be attached to said major surface, and a panel carried by said frame having said sport venue graphic depicted thereon.

19. A personalized appliance as set forth in claim 16 further comprising a second door having a major surface, and a second sport-related decoration covering substantially the entirety of the major surface of said second door, said second sport-related decoration comprising a sport team graphic depicting a sport team.

20. A personalized appliance as set forth in claim 19 wherein said second sport-related decoration comprises a thin panel permanently attached to the major surface of said second door, and wherein said sport team graphic is imprinted on an outer face of said thin panel.

21. A personalized appliance as set forth in claim 19 wherein said second sport-related decoration comprises a frame adapted to be attached to said major surface, and a panel carried by said frame having said sport team graphic depicted thereon.
